(19) United States
(12) Patent Application Publication
(10) Pub. No.: US 2019/0030995 A1
(43) Pub. Date: Jan. 31, 2019

(54) Operating element for an air outlet

(71) Applicant: Illinois Tool Works Inc., Glenview, IL (US)

(72) Inventor: Günther Krämer, Enkenbach-Alsenborn (DE)

(73) Assignee: Illinois Tool Works Inc., Glenview, IL (US)

(21) Appl. No.: 16/073,403

(22) PCT Filed: Jan. 27, 2017
(86) PCT No.: PCT/IB2017/000043

§ 371 Date: Jul. 27, 2018

(30) Foreign Application Priority Data
Jan. 27, 2016 (DE) 10 2016 101 454.0

(51) Int. Cl. B60H 1/34

(52) U.S. Cl. CPC B60H 1/3421; B60H 2001/3492; B60H 2001/3471; B60H 2001/3464

(57) ABSTRACT

An operating element (10) for an air outlet comprises an operating part (12) which has a guide (18) for a slat (7) and a first and a second side section (24, 28). Here, at least one of the side sections (24, 28) has a slot (42) on one side, and at least one part of the side section (24, 28) can be deflected elastically, a fork (14) being provided which has a first bearing journal (34) at a first end (32) and a second bearing journal (38) at an opposite second end (36), and comprises a first and a second bearing point (26, 30), the first bearing journal (34) being mounted in the first bearing point (26) and the second bearing journal (38) being mounted in the second bearing point (30), and the fork (14) being mounted in at least one of the bearing points (26, 30) without play by way of an elastic prestressing force.

### RELATED APPLICATIONS

The present application is a National Stage of International Application No. PCT/IB2017/000043, filed on Jan. 27, 2017, and claims the benefit of German Patent Application No. 10 2016 101 454.0, filed on Jan. 27, 2016.

### TECHNICAL FIELD

The invention relates to an operating element for an air outlet, in particular in motor vehicles.

### BACKGROUND

Various embodiments of operating elements for air outlets are known from the prior art. Said operating elements are frequently of multiple-piece design and have an operating part with a fork which serves to control the rear slats in the air outlet.

In the simplest embodiment, the fork is integrated rigidly into the operating part. In order to optimize the air guidance of the slats and on account of the restricted amount of available installation space, the fork is frequently mounted in a joint in the operating part. By way of adaptation of the diameters and/or the bearing spacings, the play between the fork and the operating part is minimized or generates a slight prestress, in order to achieve play-free smooth-running mounting of the fork. In addition, the operating part and the fork are usually of very stable configuration, in order for it to be possible to absorb high misuse forces during the operation.

After mounting, the fork and the operating part have no or only very low elasticity or prestress in the longitudinal and/or axial direction. The mechanical loading, above all of the fork, during mounting is not clearly defined or restricted by the construction. The mounting forces are high and are subject to great fluctuations. In addition, they lead to plastic deformation, above all of the fork, as a result of which the capability to absorb misuse forces is reduced and the function is disrupted as a result of the change in shape of the fork.

In order to minimize the forces and, as a result, the deformation during mounting, the overlaps in the bearing points are of small configuration. This leads structurally, however, to the forces which can be absorbed being reduced. Furthermore, the risk therefore rises of the fork being detached unintentionally from the operating part during operation, in particular in case of misuse.

Furthermore, the high mounting forces and the production tolerances lead to it being possible for the components to be moved freely with respect to one another directly after mounting without a force from the outside, and to the production of noise being promoted in the installed air outlet as a result. In addition, the construction loses further prestress after climate loading and/or continuous loading, as a result of post-shrinkage and/or setting behavior of the materials which are used, as a result of which the occurrence of disruptive noise is likewise promoted.

### SUMMARY OF EMBODIMENTS OF THE DISCLOSURE

An operating element for an air outlet is provided. The operating element has an operating part which comprises a guide for a slat and first and second side sections. At least one of the side sections has a slot on one side. The operating element further comprising a fork having a first bearing journal at a first end and a second bearing journal at an opposite second end. The operating part comprising a first bearing point and a second bearing point. The first bearing journal being mounted in the first bearing point and the second bearing journal being mounted in the second bearing point. The fork being mounted in at least one of the bearing points.

In some aspects, the slat has an inner stop element, which is connected to the slat, with opposite inner stops. The inner stops limits a displacement of the operating element on the slat in a longitudinal direction along the slat.

In some aspects, the inner stops have end faces and the operating part has opposing inner sides The end faces of the inner stops and the inner sides of the operating part are configured relative to one another such that forces press the first and second side sections toward the slat when the end faces engage one of the inner sides.

Optionally, the inner sides of the operating part are of complementary design with respect to the corresponding end faces of the inner stops.

In some aspects, the slot runs transversely with respect to the longitudinal direction and/or parallel to of the slat.

In some aspects, the fork determines friction generated between the operating element and the slat caused by an elastic prestressing force.

In some aspects, at least one of the bearing points with a slot has a first and a second bearing section. The first and the second bearing sections apply a force to the fork such that the fork is mounted without play.

In some aspects, the bearing axis of at least one of the bearing journals is arranged at an angle of greater than 0° with respect to the bearing axis of at least one of the bearing points, the fork being mounted without play as a result.

In some aspects, the operating part is configured in one piece from a plastic.

In some aspects, the fork is configured in one piece, in particular from a plastic.

In some aspects, the fork is mounted in at least one of the bearing points.

### BRIEF DESCRIPTION OF THE DRAWINGS

Further advantages and features result from the following description in conjunction with the appended drawings, in which:

FIG. 1 shows a perspective view of an air outlet having an operating element according to the invention,

FIG. 2 shows a perspective view of an operating element according to the invention, and

FIG. 3 shows a perspective view of the operating element from FIG. 2 without a fork.

### DETAILED DESCRIPTION OF EMBODIMENTS OF THE DISCLOSURE

It is therefore an object of the invention to provide a fork for an operating element, which fork can be mounted simply and reliably, undesired plastic deformation during mounting being prevented by the construction. Furthermore, even after climate loading and/or continuous loading, play-free mounting is to be ensured and therefore disruptive noise is to be prevented, and the fork is also to be capable of absorbing high misuse forces both during use and during mounting. Finally, the fork is to have a robust design with low sensitivity to tolerances in the components and during mounting.

In order to achieve the object, an operating element for an air outlet is provided, having an operating part which comprises a guide for a slat and a first and a second side section, at least one of the side sections having a slot on one side, and it being possible for at least one part of the side section to be deflected elastically a fork being provided which has a first bearing journal at a first end and a second bearing journal at an opposed second end, and comprises a first and a second bearing point, the first bearing journal being mounted in the first bearing point and the second bearing journal being mounted in the second bearing point, and the fork being mounted without play in at least one of the bearing points by way of an elastic prestressing force. Said operating element has the advantage that the deformation of the fork during mounting can be minimized, by it being possible for the side sections with a slot to be deflected and thus for the corresponding bearing journals to be positioned in the bearing point without deformation of the fork. Furthermore, the play-free mounting of the fork in the operating part avoids disruptive noise.

According to one preferred embodiment, the slat has an inner stop element, which is connected in one piece to the slat, with opposed inner stops, the inner stops limiting a displacement of the operating element on the slat in the slat longitudinal direction. In this way, the displacement range can be limited to the range provided for the operation and can thus prevent any misuse.

According to a further preferred embodiment, the inner stops in each case have an undercut end face, and the inner sides of the operating part are designed in such a way that, in the case of forces of the inner stops which act in the slat longitudinal direction on the inner side of the operating part, forces act in the direction of the slat plane, which forces counteract a deformation of the operating part. As a result, particularly great misuse forces can be absorbed by the operating part, since axially acting forces on the operating part lead, as a result of said design, to said operating part being compressed in the direction of the slat and enclosing the slat fixedly.

The inner sides of the operating part are preferably of complementary design with respect to the corresponding end faces of the inner stops, in order to ensure a particularly satisfactory transmission of force without deformation of the end faces or the inner sides of the operating part.

The slot can run in the side section transversely with respect to the slat longitudinal direction and/or parallel to the slat plane. This has the advantage that the mounting of the fork is facilitated as a result and, at the same time, reliable guidance of the slat is ensured.

According to a further preferred embodiment, the fork is designed in such a way that it defines the friction of the operating element on the slat by means of at least one elastic prestressing force. In this way, the displacement resistance of the operating element on the slat can be set structurally and the operating comfort can be increased in this way.

At least one of the bearing points with a slot preferably has a first and a second bearing section, the first and the second bearing section applying a force to the fork, with the result that the fork is mounted without play. As a result, the two bearing sections ensure that the fork cannot cause any disruptive noise.

The bearing axis of at least one of the bearing journals is preferably arranged at an angle of greater than 0° with respect to the bearing axis of at least one of the bearing points, the fork being mounted without play as a result. Elastic prestressing forces which ensure low-noise mounting of the fork act as a result of the oblique arrangement of the bearing axis in the bearing point.

According to one advantageous embodiment, the operating part is configured in one piece from a plastic, as a result of which it can be produced inexpensively and can have advantageous elastic properties in the case of a suitable selection of the plastic.

According to a further advantageous embodiment, the fork is configured in one piece, in particular from a plastic. A fork of this type has the advantage that it can be produced inexpensively and can be mounted simply.

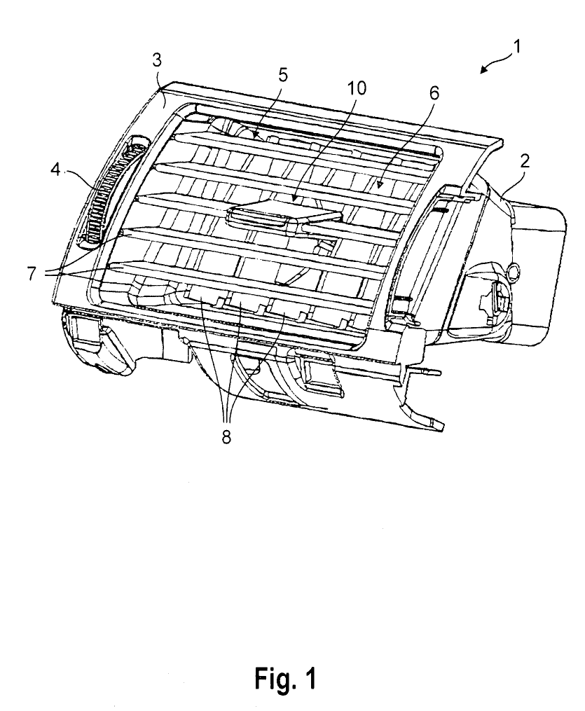

The air outlet 1 which is shown in FIG. 1 has a frame 2 which defines an air guiding channel, a faceplate 3 which can be, for example, part of a vehicle interior compartment trim, and an adjusting wheel 4 which is coupled to a shut-off flap, with the result that the air flow of the air outlet 1 can be regulated. A first slat system 5 and a second slat system 6 are arranged in the frame 2. The first slat system 5 which faces the vehicle interior compartment here has a plurality of slats 7 which are arranged parallel to one another and run horizontally in the installed state of the air outlet 1. The slats 8 of the second slat system 6 which is arranged behind the first slat system 5 here are arranged perpendicularly with respect to the slats 7 of the first slat system 5. An operating element 10 is mounted on a horizontl slat 7 of the first slat system 5, in order to adjust the slat systems 5, 6.

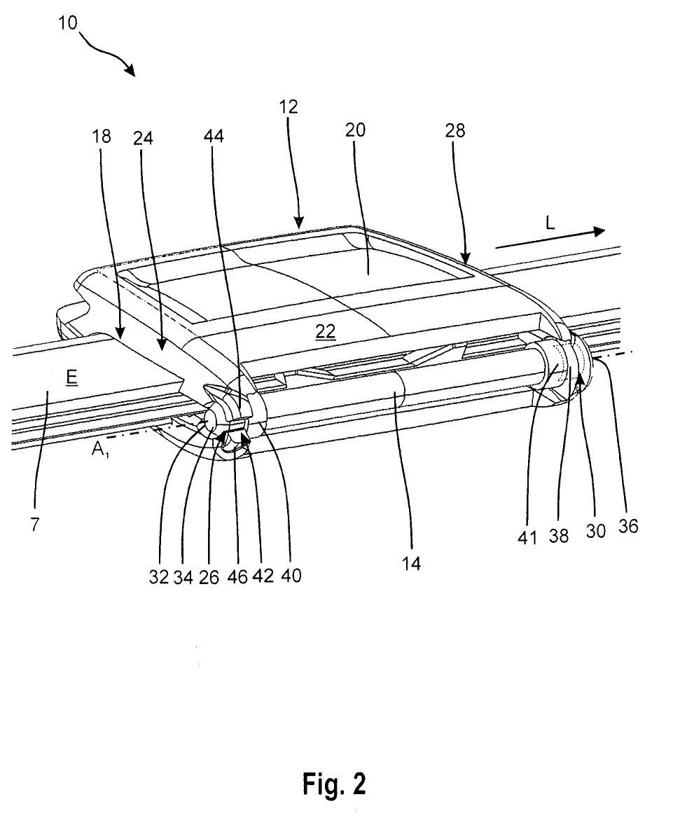

FIG. 2 shows an operating element 10 according to the invention which comprises an operating part 12 with a fork 14 and is mounted on a slat 7.

In said figure, the perspective is selected with a view out of the air outlet 1, that is to say from the frame 2 in the direction of the operating element 10 (see FIG. 1), with the result that the inner side of the operating element 10 with the fork 14 is shown from the front in this figure.

For reasons of clarity, the fork 14 is shown as a cylindrical pin without a projection, for example for actuating the second slat system 6. According to the invention, however, said projection is present on the fork 14 on the side which lies opposite with respect to the operating part 12, and can be designed in accordance with the prior art.

The operating element 10 is provided for the operation of an air outlet 1 and can be configured in one piece from a plastic.

The operating part 12 has a guide 18 which runs parallel to the slat plane E and in the slat longitudinal direction L and in which the slat 7 is arranged.

The operating part 12 has a substantially cuboid basic shape with a depression 20 on a side face 22 which is parallel to the slat plane E. The depression 20 facilitates the operation of the operating element 10 and, as an alternative, can also be provided on both sides and/or in another configuration, for example as a grooved surface.

Furthermore, the operating part 12 comprises a first side section 24 with a first bearing point 26 and a second side section 28, which is arranged opposite with respect to the first side section 24, with a second bearing point 30.

The fork 14 is designed in one piece and preferably consists of an elastic plastic.

The fork 14 has a first bearing journal 34 at a first end 32 and a second bearing journal 38 at a second end 36.

The bearing journals 34, 38 can have a bevel at one or both ends 32, 36, in order to facilitate mounting.

The fork 14 is mounted with its first bearing journal 34 in the first bearing point 26 and with its second bearing journal 38 in the second bearing point 30.

In each case one stop element 40, 41 is arranged on the first bearing journal 34 in an opposed manner with respect to the first end 32 and on the second bearing journal 38 in an opposed manner with respect to the second end 36. The stop elements 40, 41 have a greater diameter at least in sections than the diameters of the corresponding bearing journals 34, 38 and are provided for limiting the penetration depth and for axial mounting of the bearing journals 34, 38.

The first bearing journal 34 and the second bearing journal 38 have a bearing axis A₁. In one alternative embodiment, the bearing axes of the bearing journals 34, 38 are not identical and, in particular, are not parallel.

The first side section 24 has a slot 42 which separates a first bearing section 44 from a second bearing section 46.

The slot 42 runs transversely with respect to the slat longitudinal direction L and parallel to the slat plane E.

A part of the side section 24 can be deflected elastically by way of the slot 42. This property is useful, in particular, during the fastening of the operating part 12 on the slat 7.

The operating part 12 has an elastic prestressing force perpendicularly with respect to the slat plane E, by way of which elastic prestressing force the bearing sections 44, 46 mount the fork 14 without play.

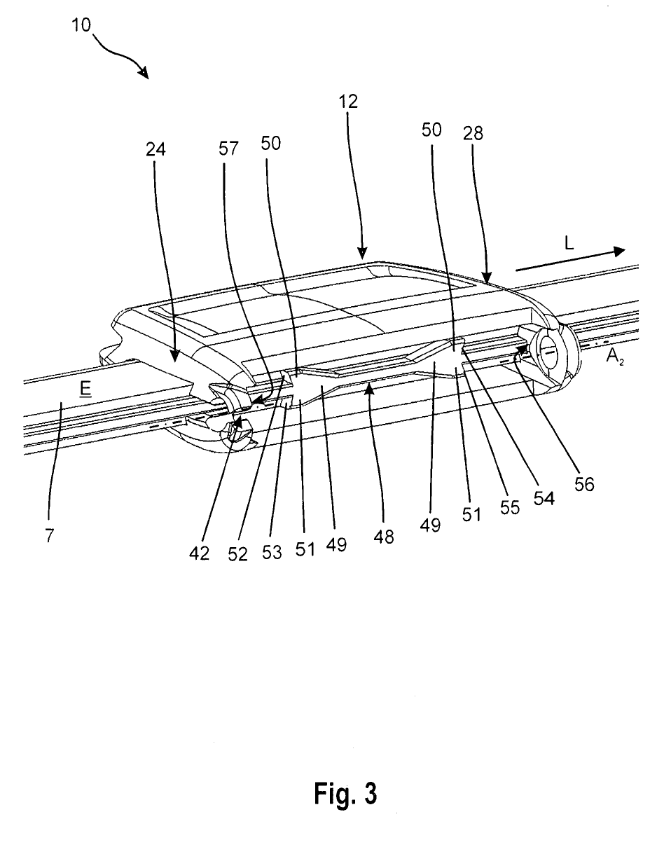

In one alternative embodiment, the fork 14 is mounted without play in the operating part 12 by the bearing axis A₁ of at least one bearing journal 34, 38 being arranged at an angle greater than 0°, that is to say not parallel, with respect to the bearing axis A₂ (see FIG. 3) of at least one of the bearing points 26, 30.

The play-free mounting of the fork 14 in the operating part 12 by way of an elastic prestressing force can also be provided as an alternative in a different way, for example by way of an interference fit of the bearing journals 34, 38 in the corresponding bearing points 26, 30 or by way of an oversize of the spacing of the stop elements 40, 41 with respect to the spacing of the bearing points 26, 30.

The fork 14 and the operating part 12 are designed in such a way that the component of the prestressing force of the operating part 12 perpendicularly with respect to the slat plane Eon the slat 7 can be fixed via the diameter of the first bearing journal 34 or the first bearing point 26. As a result, the friction and therefore the operating comfort can be set structurally between the operating part 12 and the slat 7.

As an alternative, the fork 14 can also be designed in such a way that it bears against the slat 7 in sections, in particular on its side which faces the slat 7, and in this way defines the displacement resistance of the operating part 12 on the slat 7.

In order to mount the operating element 10 on the slat 7, the slat 7 is pushed into the guide 18 of the operating part 12 in a first step. Subsequently, the fork 14 is fastened in the operating part 12 in a second step, by first of all the second bearing journal 38 being inserted into the second bearing point 30 and subsequently the first bearing journal 34 being pressed by way of the slot 42 into the first bearing point 26.

In order to rule out a deformation of the fork 14, the side section 24 can additionally be deflected elastically, for example by way of a corresponding mounting tool, as a result of which the fork 14 can slide virtually without force into the operating part 12.

In one embodiment, in which the operating part 12 has a slot 42 on both side sections 24, 28, the operating part 12 can also be pushed laterally onto the slat 7. Here, in addition, the fork 14 can be inserted at the same time or one after another by way of the slots 42 into the corresponding bearing points 26, 30.

FIG. 3 shows the operating element 10 without the fork 14.

The slat 7 has an inner stop element 48 which is connected in one piece to the slat 7 and is arranged within the operating part 12. The inner stop element 48 comprises two wedge-shaped sections 49 with inner stops 50, 51 which are opposed in each case with respect to one another and limit a displacement of the operating element 10 on the slat 7 in the slat longitudinal direction L.

The inner stops 50, 51 have end faces 52, 53, 54, 55 which are undercut perpendicularly with respect to the slat plane E.

The inner sides 56, 57 of the operating part 12 are designed in such a way that forces act perpendicularly in the direction of the slat plane E when the inner stops 50, 51 press onto the inner side 56, 57 of the operating part 12, and forces act in the slat longitudinal direction L on the corresponding inner side 56, 57 of the operating part 12. As a result, a deformation of the operating part 12 is counteracted. It is prevented, in particular, that the side sections 24, 28 with a slot 42 are deflected and the inner stop element 48 slips out of the operating part 12 or the fork 14 (see FIG. 2) falls out of the operating part 12.

To this end, the inner sides 56, 57 can be of wedge-shaped design.

In one preferred embodiment, the inner sides 56, 57 of the operating part 12 are of complementary design with respect to the corresponding end faces 52, 53, 54, 55 of the inner stops 50, 51.

1. An operating element for an air outlet, having an operating part which comprises a guide for a slat and a first and a second side section, at least one of the side sections having a slot on one side, the operating element further comprising a fork having a first bearing journal at a first end and a second bearing journal at an opposite second end, the operating part comprising a first bearing point and a second bearing point, the first bearing journal being mounted in the first bearing point and the second bearing journal being mounted in the second bearing point, and the fork being mounted in at least one of the bearing points.

2. The operating element of claim 1, wherein the slat has an inner stop element, which is connected to the slat, with opposite inner stops, the inner stops limiting a displacement of the operating element on the slat in a longitudinal direction (L) along the slat.

3. The operating element of claim 2, wherein the inner stops have end faces and the operating part has opposing inner sides, wherein the end faces of the inner stops and the inner sides of the operating part are configured relative to one another such that forces press the first and second side sections toward the slat when the end faces engage one of the inner sides.

4. The operating element of claim 3, wherein the inner sides of the operating part are of complementary design with respect to the corresponding end faces of the inner stops.

5. The operating element of claim 1, wherein the slot runs transversely with respect to the longitudinal direction and/or parallel to of the slat.

6. The operating element as claimed in claim 1, wherein the fork determines friction generated between the operating element and the slat caused by an elastic prestressing force.

7. The operating element as claimed in claim 1, wherein at least one of the bearing points with a slot has a first and a second bearing section, the first and the second bearing section applying a force to the fork such that the fork is mounted without play.

8. The operating element as claimed in claim 1, wherein the bearing axis of at least one of the bearing journals is arranged at an angle of greater than 0° with respect to the bearing axis of at least one of the bearing points, the fork being mounted without play as a result.

9. The operating element as claimed in claim 1, wherein the operating part is configured in one piece from a plastic.

10. The operating element as of claim 1, wherein the fork is configured in one piece, in particular from a plastic.

11. The operating element of claim 1, wherein the fork being mounted in at least one of the bearing points.
